(19) United States
(12) Patent Application Publication
(10) Pub. No.: US 2025/0252633 A1
(43) Pub. Date: Aug. 7, 2025

(54) AI-DRIVEN AUDIO-VISUAL LIVE ENTERTAINMENT PLATFORM

(71) Applicant: Compeller LLC, San Clemente, CA (US)

(72) Inventor: Yakoob AHMAD, San Clemente, CA (US)

(21) Appl. No.: 19/044,605

(22) Filed: Feb. 3, 2025

Related U.S. Application Data
(60) Provisional application No. 63/549,560, filed on Feb. 4, 2024.

(51) Int. Cl. G06T 11/60; G10L 15/18; G10L 25/57; G10L 25/63

(52) U.S. Cl. CPC G06T 11/60; G10L 15/1815; G10L 15/1822; G10L 25/57; G10L 25/63; G06T 2200/24

(57) ABSTRACT

Certain aspects of the disclosure provide a method for presenting an artificial intelligence (AI)-enhanced visual experience, comprising: receiving audio content from an audio content source; processing audio content to obtain audio analysis outputs; translating a first portion of the audio analysis outputs to obtain an audio semantic description; processing a second portion of the audio analysis outputs and the audio semantic description to create a storytelling theme; mapping at least the audio semantic description and the storytelling theme to a visual element set; selecting one of a selection group comprising the visual element set and a visual element subset of the visual element set; creating a visual narrative using the one of the selection group, the visual narrative comprising a video constructed by the AI; and displaying the visual narrative through a visual content target.

### CROSS-REFERENCE TO RELATED APPLICATIONS

This Application claims the benefit of and priority to U.S. Provisional Patent Application No. 63/549,560, filed on Feb. 4, 2024, the entire contents of which are hereby incorporated by reference.

### BACKGROUND

Aspects of the present disclosure relate generally to live entertainment systems, and more particularly, to an artificial intelligence (AI)-driven audio-visual (AV) live entertainment platform.

Existing systems in live entertainment often lack real-time adaptability and interactivity, resulting in static and pre-planned visual experiences that cannot dynamically synchronize with live performances. Ultimately, this limits audience engagement and the creative potential of artists.

Currently, there are no existing live entertainment systems which provide real time, responsive visuals that adapt seamlessly to the live performance or otherwise create immersive and interactive experiences for viewers while, at the same time, providing enhanced creative freedom to artists and content producers.

### SUMMARY

One aspect provides a method for presenting a visual experience, comprising: receiving, by an audio input interface, audio content from an audio content source; processing, by an audio analysis module, the audio content to obtain audio analysis outputs; translating, by a generative artificial intelligence (AI) model, a first portion of the audio analysis outputs to obtain an audio semantic description; processing, by the generative AI model, a second portion of the audio analysis outputs and the audio semantic description to create a storytelling theme; mapping, by a video conversion engine, at least the audio semantic description and the storytelling theme to a visual element set; selecting, by the video conversion engine, one of a selection group comprising the visual element set and a visual element subset of the visual element set; creating, by a storytelling algorithm, a visual narrative using the one of the selection group, the visual narrative comprising a video constructed by artificial intelligence; and displaying, by a visual controller, the visual narrative through a visual content target.

Another aspect provides a live entertainment platform incorporating artificial intelligence (AI) and comprising: a computing device comprising a first computer processor, the first computer processor configured to support: an audio input interface configured to receive audio content, the audio input interface comprising an audio metadata manager, and the audio metadata manager configured to handle audio metadata associated with the audio content, an audio analysis module configured to process the audio content to obtain audio analysis outputs, a generative AI model configured to process the audio analysis outputs to obtain generative AI outputs, and a storytelling algorithm configured to create a visual narrative using one of a selection group comprising a visual element set and a visual element subset of the visual element set; a graphics processing unit configured to support a video conversion engine, the video conversion engine configured to map the generative AI outputs to the visual element set; a storage device comprising a second computer processor, the second computer processor configured to support a visual element library, and the visual element library configured to store visual elements created by the artificial intelligence; a visual controller comprising a third computer processor, the third computer processor configured to display the visual narrative; a customization and control interface comprising a fourth computer processor, the fourth computer processor configured to configure the live entertainment platform for an entertainment venue; and an edge computing device comprising a fifth computer processor, the fifth computer processor configured to support an interactive feedback system, and the interactive feedback system configured to receive ambient feedback used to adjust the visual narrative.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example artificial intelligence-driven audio-visual live entertainment platform in accordance with one or more aspects described herein.

FIG. 2A depicts an example audio input interface in accordance with one or more aspects described herein.

FIG. 2B depicts an example audio analysis module in accordance with one or more aspects described herein.

FIG. 2C depicts an example generative AI model in accordance with one or more aspects described herein.

FIG. 2D depicts an example video conversion engine in accordance with one or more aspects described herein.

FIG. 2E depicts an example storytelling algorithm in accordance with one or more aspects described herein.

FIGS. 3A-3C depict a flowchart describing an example method for presenting an AI-enhanced visual experience in accordance with one or more aspects described herein.

FIG. 4 depicts a flowchart describing an example method for presenting an AI-enhanced visual experience in accordance with one or more aspects described herein.

FIG. 5 depicts a flowchart describing an example method for general execution of a storytelling algorithm in accordance with one or more aspects described herein.

FIGS. 6A and 6B depict a flowchart describing an example method for execution of a storytelling algorithm given a text input in accordance with one or more aspects described herein.

FIG. 7 depicts a flowchart describing an example method for execution of a storytelling algorithm given an image or video input in accordance with one or more aspects described herein.

FIG. 8 depicts an example venue setup in accordance with one or more aspects described herein.

FIG. 9 depicts an example computing system in accordance with one or more aspects described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, computing systems, and computer-readable mediums for presenting an AI-enhanced visual experience.

As mentioned above, existing systems in live entertainment often lack real-time adaptability and interactivity, resulting in static and pre-planned visual experiences that cannot dynamically synchronize with live performances, such as musical concerts, festivals, symphonies, places of religious gathering (e.g., churches), and theater plays. Ultimately, this limits audience engagement and the creative potential of artists. Unfortunately, there are no existing live entertainment systems that provide real-time, responsive visuals that adapt seamlessly to the live performance or otherwise create immersive and interactive experiences for viewers while concurrently providing enhanced creative freedom to artists and content producers.

Aspects described herein overcome these issues by utilizing AI in a novel manner to create synchronized, dynamic visual experiences that directly respond to live inputs of varying modalities (e.g., audio, visual, environmental, social media, etc.). Specifically, aspects described herein enhance audience engagement through immersive, real-time visuals that offer performers new avenues for creative expression. Additionally, aspects described herein beneficially reduce the cost and complexity of visual production, thereby allowing personal experiences to meet the growing demand for advanced technology integration in entertainment. The adaptability and responsiveness to live performance elements make aspects described herein a versatile and innovative solution in the live entertainment industry.

Aspects described herein differ from and improve upon currently existing live entertainment systems and devices, which are unable to adjust visuals in real-time to match the spontaneity and nuances of live performances. Consequently, existing systems and devices in the live entertainment industry are less engaging for audiences and the experiences are less interactive for both the audience and the performers alike. In contrast, aspects described herein uniquely integrate AI, including in some examples large language models and real-time video conversion technology, to create highly adaptive, synchronized visual experiences for live entertainment. As such, aspects described herein enable new technological capabilities compared to existing systems and devices that are unable to dynamically and automatically respond to live inputs of varying modalities to enhance audience engagement and artistic expression.

### Example AI-Driven AV Live Entertainment Platform for Presenting an AI-Enhanced Visual Experience

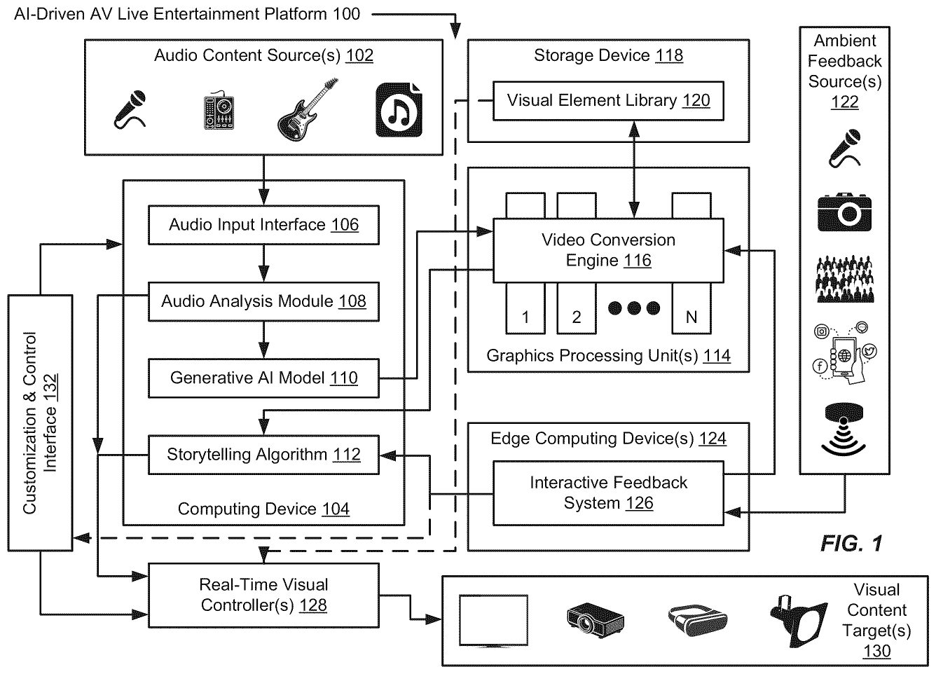

FIG. 1 depicts an example AI-driven AV live entertainment platform 100, which may be referred to as the example platform 100 for brevity herein. The example platform 100 includes one or more audio content sources 102, a computing device 104, one or more graphics processing units (GPUs) 114, a storage device 118, one or more ambient feedback sources 122, one or more edge computing devices 124, one or more real-time visual controllers 128, one or more visual content targets 130, and a customization and control interface 132. Each of these components is described further below. Note that while the example in FIG. 1 shows, for example, a single computing device 104 and a single customization and control interface 132, in other examples, there may be multiple computing devices 104 and multiple customization and control interfaces 132

The audio content source(s) 102 may each represent a physical or visual/digital source from which audio content originates and/or is produced. Audio content, in turn, may refer to audio-based content or data. Examples of the audio content source(s) 102 include, but are not limited to, a microphone, disc-jockey (DJ) equipment (e.g., DJ controller, turntable, DJ mixer, DJ deck, DJ software, etc.), a musical instrument, audio mixer, and a digital music/audio file.

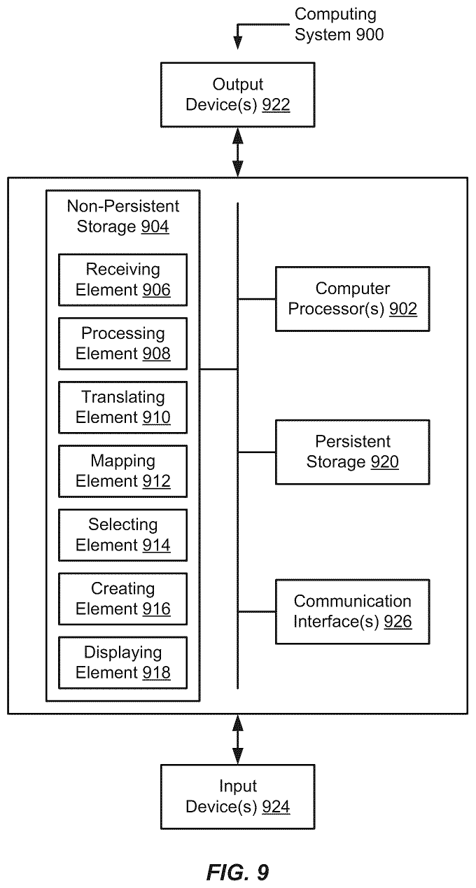

The computing device 104 may include a physical appliance configured to receive, generate, process, store, and/or transmit data, as well as to provide an environment in which one or more workloads may execute thereon. A workload may refer, but is not limited, to a service offered locally or over a network (not shown), a computational task or function, a data transaction, or a software application/program. Further, in providing the execution environment for any workload(s) instantiated thereon, the computing device 104 may include or have access to, and thus allocate and de-allocate, various computing resources (e.g., computer processors, memory, storage, virtualization, network bandwidth, etc.), as needed, to the workload(s). Examples of the computing device 104 include, but are not limited to, a desktop computer, a laptop computer, a network server, a small-form factor or next unit of computing (NUC) computer, or any computing system similar to the example computing system illustrated and described with respect to FIG. 9, below.

The computing device 104 includes an audio input interface 106, an audio analysis module 108, a generative AI model 110, and a storytelling algorithm 112. Each of these subcomponents is described below.

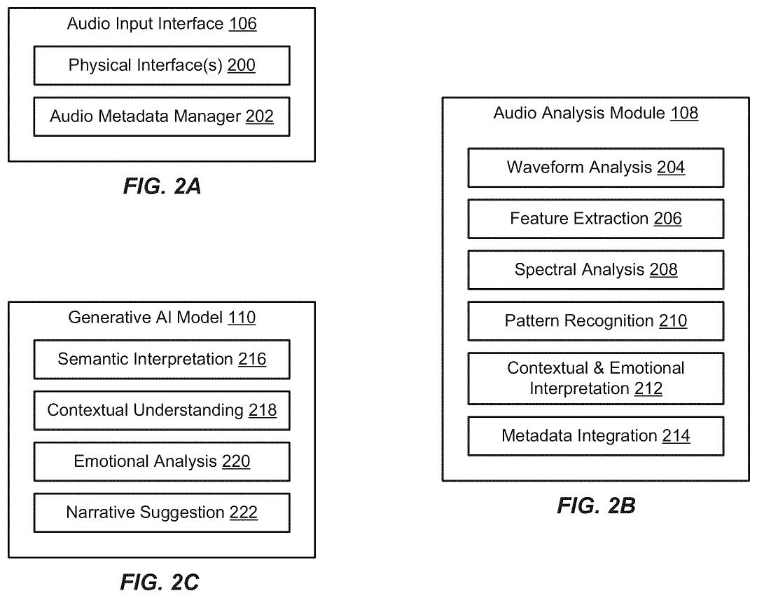

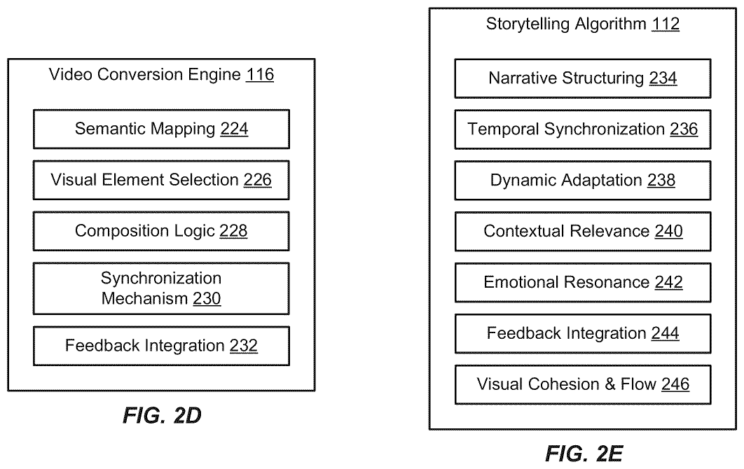

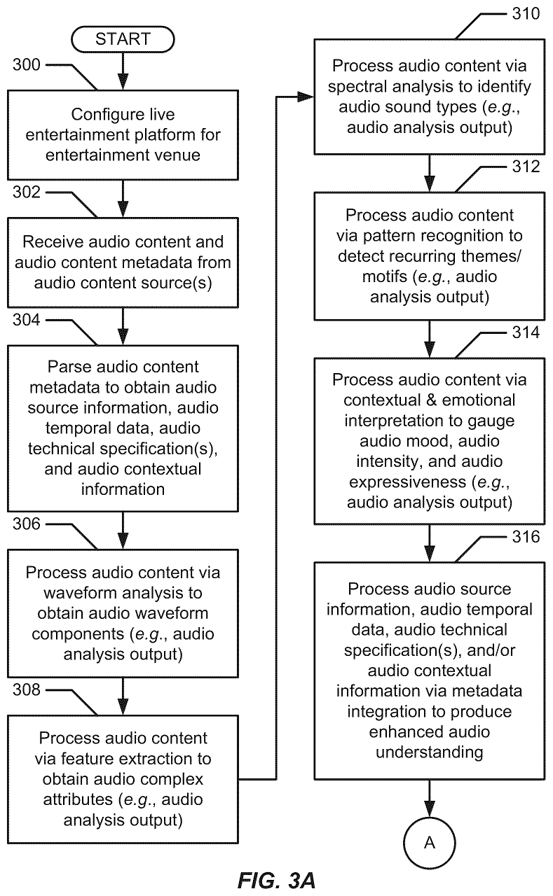

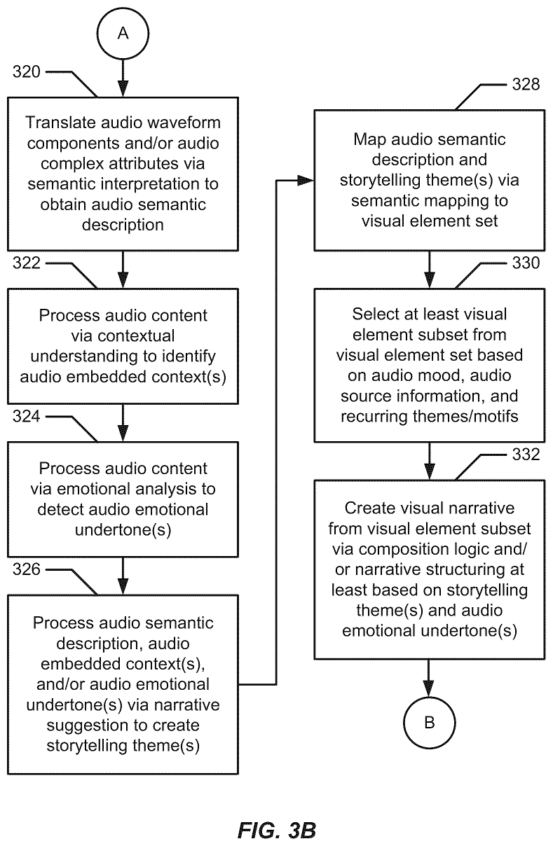

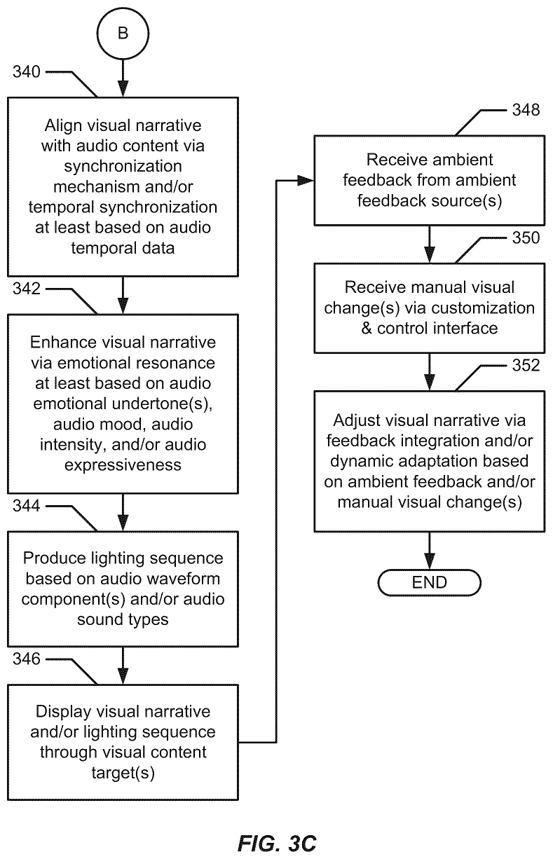

The audio input interface 106 may be implemented in hardware (e.g., audio receiver, AV analog-to-digital converter, etc.), software (e.g., digital audio workstation, etc.), or a combination thereof, and configured to receive (or capture) audio content, as well as audio content metadata, from the audio content source(s) 102. The audio input interface 106 is illustrated and discussed in further detail below with respect to FIG. 2A.

The audio analysis module 108 may be implemented in hardware (e.g., computer processors), software (e.g., a computer program/application), or a combination thereof, and configured to process any audio content received (or captured) by the audio input interface 106. Through processing of the audio content using one or more functionalities (described below), the audio analysis module 108 produces one or more audio analysis outputs. The audio analysis module 108 is illustrated and discussed in further detail below with respect to FIG. 2B.

The generative AI model 110 may be implemented in hardware (e.g., computer processors), software (e.g., a computer program/application), or a combination thereof, and configured to process the audio analysis output(s) produced by the audio analysis module 108. The generative AI model 110 may generate text, images, and/or other data modalities (e.g., videos) using generative statistical and machine learning models, such as language models (e.g., large language models (LLMs), small language models (SLMs), etc.). Further, through processing of the audio analysis output(s) using one or more functionalities (described below), the generative AI model 110 produces one or more generative Al outputs. The generative Al output(s) may result based on prompts, entailing natural language text, describing tasks sought to be performed by the generative AI model 110. The generative AI model 110 is illustrated and discussed in further detail below with respect to FIG. 2C.

The storytelling algorithm 112 may be implemented in software (e.g., a computer program/application) and configured to merge together visual elements (e.g., generative AI created images, graphics, illustrations, animations, videos, etc.) stored on, and thus selected from, the storage device 118. Through merging of the visual elements using one or more functionalities (described below), the storytelling algorithm 112 creates a cohesive and engaging visual narrative. The storytelling algorithm 112 is illustrated and discussed in further detail below with respect to FIG. 2D.

The GPU(s) 114 may each be implemented in hardware (e.g., specialized computer processors) and designed to accelerate demanding workloads (e.g., image processing, video editing, 3D graphics rendering, etc.) through parallel processing. Note that while GPUs are used as one example herein, other types of processing accelerators may be used as alternatives, such as tensor processing units (TPUs), neural processors, and other types of AI accelerators.

The GPU(s) 114, separately or in combination, may support or include a video conversion engine 116. The video conversion engine 116 may be implemented in software (e.g., a computer program/application) and configured to process at least a portion of the generative AI output(s) produced by the generative AI model 110. Through processing of the at least portion of the generative Al output(s) using one or more functionalities (described below), the video conversion engine 116 selects visual elements from the storage device 118 for subsequent merging by the storytelling algorithm 112. The video conversion engine 116 is illustrated and described in further detail below with respect to FIG. 2D.

The storage device 118 may be implemented in hardware (e.g., non-transitory computer readable media) and configured to store one or more forms of digital information (e.g., structured and unstructured data) in whole or in part, and temporarily or permanently. By way of an example, the storage device 118 may embody network attached storage (NAS) including optical storage, magnetic storage, and/or solid state storage elements.

The storage device 118 may support or include a visual element library 120. The visual element library 120 may represent a logical repository configured to store and manage various visual elements, including, but not limited to, images, graphics, illustrations, animations, and videos. The visual elements may be AI created or constructed by way of the video conversion engine 116. Furthermore, the visual elements may exhibit or express a variety of themes (or motifs) and styles, and may be categorized intelligently based on one or more factors (e.g., mood, theme, etc.).

The ambient feedback source(s) 122 may each represent a physical source from which ambient feedback originates and/or is produced. Ambient feedback, in turn, may refer to information capturing feedback or reactions to an encompassing atmosphere or environment (e.g., a live performance at an entertainment venue) in which the example platform 100 is deployed. Examples of the ambient feedback source(s) 122 include, but are not limited to, a microphone (which provides audio feedback), a camera (which provides visual feedback), an audience and/or social media (which provides interactive feedback), and an environmental sensor (which provides environmental factor feedback, such as temperature, sound level, light, etc.).

The edge computing device(s) 124 may each represent a physical appliance configured to receive, generate, process, store, and/or transmit data, as well as to provide an environment in which one or more workloads (described above) may execute thereon. In providing the execution environment for any workload(s) instantiated thereon, the edge computing device(s) 124 may each include or have access to, and thus allocate and de-allocate, various computing resources (e.g., computer processors, memory, storage, virtualization, network bandwidth, etc.), as needed, to the workload(s). Examples of the edge computing device(s) 124 include, but are not limited to, a small-form factor or NUC computer, an Internet of Things (IoT) device, a data acquisition device, or any computing system similar to the example computing system illustrated and described with respect to FIG. 9, below.

The edge computing device(s) 124, separately or in combination, may support or include an interactive feedback system 126. The interactive feedback system 126 may be implemented in software (e.g., a computer program/application) and configured to receive (or capture) ambient feedback from the ambient feedback source(s) 122. The interactive feedback system 126 may subsequently process the received ambient feedback to discern contextual and/or content-based insights (e.g., patterns, reactions, sentiment changes, etc.) therefrom. The insights, which may resonate with the current mood of the ambience of a live entertainment performance, may then be provided to the storytelling algorithm 112, the video conversion engine 116, and/or the customization and control interface 132 for incorporation into, or adjustment of, the visual narrative(s) displayed concurrent with, and as a technological enhancement to, the live entertainment performance.

The real-time visual controller(s) 128 may each be implemented in hardware (e.g., physical device including computer processors), software (e.g., a computer program/application), or a combination thereof, configured to display the visual narrative(s) created by the storytelling algorithm 112 or, alternatively, lighting sequences constructed based on at least a portion of the produced audio analysis output(s), through the visual content target(s) 130. The real-time visual controller(s) 128 may each further enable adaptive visual processing in which the visual narrative(s) and/or the lighting sequences adjust to changes in the ambience, as captured by the interactive feedback system 126. Examples of the real-time visual controller(s) 128 include, but are not limited to, a programmable lighting controller (e.g., using a digital multiplex (DMX) and/or open sound control (OSC) protocol) and a programmable media player.

The visual content target(s) 130 may each represent a physical output target (e.g., a visual output device) through which visual content may be displayed. Visual content, in turn, may refer to visual based content or material, such as visual narratives, images, graphics, illustrations, animations, videos, and lighting sequences. Examples of the visual content target(s) 130 include, but are not limited to, a display screen, a media projector, a virtual reality device, an augmented reality device, and a lighting device. Note that as used herein, lighting devices can include diffuse lighting devices, such as light bulbs, as well as concentrated lighting devices, like laser devices.

The customization and control interface 132 may be implemented in hardware (e.g., a physical device including computer processors), software (e.g., a computer program/application), or a combination thereof, and configured to enable users to configure the example platform 100 for a given entertainment venue (e.g., concert, night club, symphony, theater, etc.). To that extent, and through the customization and control interface 132, users may personalize and control any visual narrative(s) in real-time, thereby ensuring that the presented AI-enhanced visual experience(s) align seamlessly with the diverse requirements of the given entertainment venue. For example, users may opt to present more vibrant and high-energy visuals for concert or club-based entertainment venues, while opting to present more refined and subtle visuals for symphony or theater-based entertainment venues. The customization and control interface 132 may include further functionality to permit users to introduce manual visual changes into, and thus cause the adjustment of, the visual narrative(s) and/or lighting sequences in real-time through connectivity to the computing device 104 and/or the real-time visual controller(s) 128.

While FIG. 1 shows a configuration of elements, other configurations may be used without departing from the scope described herein. For example, in alternative embodiments, aspects described with respect to the example platform 100 may be omitted, added, or substituted for alternative aspects.

### Example Audio Input Interface for Presenting an AI-Enhanced Visual Experience

FIG. 2A depicts an example audio input interface 106, as depicted in FIG. 1. The example audio input interface 106 includes one or more physical interfaces 200 and an audio metadata manager 202. Each of these subcomponents is described below.

The physical interface(s) 200 each serve as a tangible connector through which data communications from an audio content source 102, as depicted in FIG. 1, is received. For analog audio content source(s) 102 (e.g., microphones, some DJ equipment, musical instruments), the physical interface(s) 200 include one or more analog audio connection ports, of the same or differing type(s) (e.g., Radio Corporation of America (RCA) port, 3.5 millimeter (mm) auxiliary (aux) stereo jack, 6.5 mm aux stereo jack, external line return (XLR) port, etc.), which may facilitate the reception of analog audio signals. Similarly, for digital audio content source(s) 102 (e.g., other DJ equipment, digital audio files), the physical interface(s) include one or more digital audio connection ports, of the same or differing type(s) (e.g., universal serial bus (USB) port, Sony/Philips Digital Interconnect Format (S/PDIF) port, high-definition multimedia interface (HDMI) port, digital optical audio port, etc.), which may facilitate the reception of digital audio signals or data.

The audio metadata manager 202 may be implemented in hardware (e.g., computer processors), software (e.g., a computer program/application), or a combination thereof, and configured to process or parse any audio content metadata received (or captured) by the audio input interface 106 depicted in FIG. 1. Audio content metadata generally refers to information that describes the audio content. Examples of audio content metadata may include, but is not limited to, audio source information, audio temporal data, audio technical specifications, and audio contextual information.

The audio source information may refer to information detailing an origin of the audio content. Examples of audio source information include, but are not limited to, a type of a musical instrument, a type of audio equipment (e.g., DJ equipment), and a personal identity of a speaker/singer employing a microphone.

The audio temporal data may refer to time related information associated with the audio content. Examples of audio temporal data include, but are not limited to, a timestamp (i.e., data encoding a capture date and/or time), beats per minute (BPM), tempo, and a duration (i.e., length of time), of the audio content. The audio temporal data may be useful for the synchronization of the audio content with any created visual narrative(s).

The audio technical specifications may refer to quality related information associated with the audio content. Examples of an audio technical specification includes, but are not limited to, a sample rate (e.g., number of samples of the audio content recorded per second), a bit depth (e.g., number of bits used to represent each sample of the audio content), and a bit rate (e.g., number of bits used to represent one second of the audio content).

The audio contextual information may reference a collection of data providing a digital identity for the audio content. By way of an example, audio contextual information includes one or more tags or labels (e.g., artist name, song title, genre/mood, key, album, release year, comments, other metadata associated with the audio, etc.) embedded within a digital music file.

While FIG. 2A shows a configuration of elements, other configurations may be used without departing from the scope described herein. For example, in alternative embodiments, aspects described with respect to the example audio input interface 106 may be omitted, added, or substituted for alternative aspects.

### Example Audio Analysis Module for Presenting a Visual Experience

FIG. 2B depicts an example audio analysis module 108, as depicted in FIG. 1. The example audio analysis module 108 performs various functionalities, including: waveform analysis 204, feature extraction 206, spectral analysis 208, pattern recognition 210, contextual and emotional interpretation 212, and metadata integration 214. Each of these functionalities is described below.

Waveform analysis 204 may refer to an audio analysis technique through which a detailed analysis of an audio waveform of the audio content is conducted. An audio waveform, in turn, may refer to a depiction of the pattern of sound pressure variation, in the time domain, associated with the audio content. Further, through waveform analysis 204, one or more audio waveform components (e.g., an audio analysis output) may be obtained. Examples of the audio waveform component(s) include(s), but are not limited to, frequency (or pitch), amplitude (or loudness), speed (or tempo), and pattern of changes in amplitude over time (or rhythm). An example input to waveform analysis 204 is an audio stream and example outputs are a spectrograph indicating an energy level of the audio, a spectral roll-off, decay time, envelope shape (of the audio waveform), and others which can be used downstream to affect the visual output of the system.

Feature extraction 206 may refer to an audio analysis technique through which audio content is transformed into one or more meaningful audio content features (also referred to herein as audio complex attributes) (e.g., an audio analysis output). An audio complex attribute, in turn, may refer to an essential characteristic of the audio content. Examples of the audio complex attribute(s) include(s), but are not limited to, a harmonic pattern, a beat strength, and an audio timbre. An example input to feature extraction 206 is an audio stream and an example output is an energy level, which could be representative of an amplitude over a given envelope.

Spectral analysis 208 may refer to an audio analysis technique through which a distribution of energy (or power), across different frequency bands, of the audio content is obtained. An understanding of the distribution of energy/power may identify one or more specific types of sounds (or audio sound types) (e.g., an audio analysis output) present in the audio content. Examples of the audio sound type(s) include(s), but are not limited to, a musical note, a vocal tone, and an ambient/background sound. An example input to spectral analysis 208 is an audio stream and an example output is a spectrum of the audio stream.

Pattern recognition 210 may refer to an audio analysis technique through which one or more intricate patterns, embedded within audio content, is/are detected and decoded. These pattern(s) (also referred to herein as recurring theme(s) or motif(s)) (e.g., an audio analysis output) may reflect highly useful information for long duration and/or complex-structured performances. An example input to pattern recognition 210 is an audio stream and an example output is an identified pattern (e.g., a geometrical, metronomic, or numeric pattern).

Contextual and emotional interpretation 212 may refer to an audio analysis technique through which an emotional tone and context of the audio content are assessed. Through the assessment, one or more emotionally-resonant aspects (e.g., an audio analysis output) of the audio content may be gauged. Examples of the emotionally-resonant aspect(s) include(s), but are not limited to, an audio mood, an audio intensity, and an audio expressiveness. An example input to contextual and emotional interpretation 212 is an audio stream and an example output is an identified emotion or emotional energy level associated with the audio stream.

Metadata integration 214 may involve producing an enhanced audio understanding of the audio content through a deeper analysis of one or more audio content metadata. For example, at a given time, an audio player is in a certain state, playing a certain audio track, in a certain way (e.g., looping), etc.

While FIG. 2B shows a configuration of elements, other configurations may be used without departing from the scope described herein. For example, in alternative embodiments, aspects described with respect to the example audio analysis module 108 may be omitted, added, or substituted for alternative aspects.

### Example Large Language Model for Presenting an AI-Enhanced Visual Experience

FIG. 2C depicts an example generative AI model 110, as depicted in FIG. 1. The example generative AI model 110 performs various functionalities, including: semantic interpretation 216, contextual understanding 218, emotional analysis 220, and narrative suggestion 222. Each of these functionalities is described below. In various aspects, generative AI model 110 may be a large or small language model.

Semantic interpretation 216 may refer to an artificial intelligence technique through which time- and/or frequency-based aspects of the audio content is/are interpreted in terms of text-based language. Particularly, one or more of: the audio waveform component(s) and the audio complex attribute(s) may be translated into an audio semantic description, which reflects an understanding of the audio content via the context of human language and experience.

Contextual understanding 218 may refer to an artificial intelligence technique through which context information, embedded within the audio content, is identified. The context information (or audio embedded context(s)) may be associated with a certain genre, a certain mood of any speech, or a certain sentiment of environmental sounds. The audio embedded context(s) may enhance the storytelling of visual narratives.

Emotional analysis 220 may refer to an artificial intelligence technique through which one or more audio emotional undertones, of the audio content, is/are detected. An audio emotional undertone, in turn, may refer to an implicit meaning or subdued emotion (e.g., melancholy, happiness, excitement, anger, etc.) present in the audio content.

Narrative suggestion 222 may refer to an artificial intelligence technique through which one or more storytelling themes (or arcs) that complement the audio content is/are created. Creation of the storytelling theme(s) may entail processing of one or more of: the audio semantic description, the audio embedded context(s), and the audio emotional undertone(s).

While FIG. 2C shows a configuration of elements, other configurations may be used without departing from the scope described herein. For example, in alternative embodiments, aspects described with respect to the example generative AI model 110 may be omitted, added, or substituted for alternative aspects.

### Example Video Conversion Engine for Presenting an AI-Enhanced Visual Experience

FIG. 2D depicts an example video conversion engine 116, as depicted in FIG. 1. The example video conversion engine 116 includes: a semantic mapping 224 function, a visual element selection 226 function, a composition logic 228, a synchronization mechanism 230, and feedback integration 232. Each of these elements is described below.

Semantic mapping 224 may refer to a video conversion technique through which a visual element set stored in the visual element library 120 is identified. Identification of the visual element set may entail interpreting the audio semantic description and/or the storytelling theme(s), provided by the example generative AI model 110 (e.g., as discussed with respect to FIG. 2C), to understand what types of visuals would best represent the audio content.

Visual element selection 226 may refer to a video conversion technique through which the visual element set in entirety, or a visual element subset thereof, is selected for composition of the visual narrative. The technique is dynamic and may depend on one or more factors, including, but not limited to, an audio mood, audio source information (e.g., genre and/or rhythm), and any recurring theme(s)/motif(s) associated with the audio content. By way of examples, calm/serene audio content may prompt the selection of gentle visual elements, whereas high-energy audio content may alternatively prompt the selection of more vibrant/rapid visual elements.

Composition logic 228 may refer to a video conversion technique through which one or more coherent and engaging visual narratives is/are created based on the selected visual elements. Creation of the visual narrative(s) rely on the storytelling theme(s) and/or audio emotional undertone(s) provided by the example generative AI model 110. Further, the creation of the visual narrative(s) may entail determining the sequence, duration, transitions, and interactions of or between the selected visual elements.

The synchronization mechanism 230 may refer to a video conversion technique through which the visual narrative(s) is/are synchronized with the audio content. Particularly, the technique ensures that the visual narrative(s) unfold(s) in relation to the audio content, such as accounting for the audio temporal data, as well as any adjustment(s) in real-time to change(s) in the tempo, intensity, and mood of the audio content.

Feedback integration 232 may refer to a video conversion technique through which ambient feedback, received from one or more ambient feedback sources 122 (as described with respect to FIG. 1), is incorporated into the visual narrative creation process. Feedback integration 232 enables the visual narrative(s) to be reactive, not only to the audio content itself, but also to one or more external factors reflective of the entertainment venue atmosphere.

While FIG. 2D shows a configuration of elements, other configurations may be used without departing from the scope described herein. For example, in alternative embodiments, aspects described with respect to the example video conversion engine 116 may be omitted, added, or substituted for alternative aspects.

### Example Storytelling Algorithm for Presenting an AI-Enhanced Visual Experience

FIG. 2E depicts an example storytelling algorithm 112, as depicted in FIG. 1. The example storytelling algorithm 112 performs various functionalities, including: narrative structuring 234, temporal synchronization 236, dynamic adaptation 238, contextual relevance 240, emotional resonance 242, feedback integration 244, and visual cohesion and flow 246. Each of these functionalities is described below.

Narrative structuring 234 may refer to a storytelling technique through which the selected visual elements, provided by the example video conversion engine 116 (described with respect to FIG. 2D), are arranged in a sequence that tells a story or conveys a theme. The technique, therefore, relies on one or more of: the storytelling theme(s) and the emotional undertone(s) provided by the example generative AI model 110 (as described with respect to FIG. 2C). An example input to narrative structuring 234 is text, video, image, and/or audio and an example output is an image and a video, where the image may be a frame in the video, such as a last frame in the video. Narrative structuring 234 can perform as a recursive function.

Temporal synchronization 236 may refer to a storytelling technique through which the visual narrative(s) is/are synchronized with the audio content. Temporal synchronization 236 functions similarly to the synchronization mechanism 230 functionality of the video conversion engine 116 (described with respect to FIG. 2D). An example input to temporal synchronization 236 is metadata including a timestamp and an example output from temporal synchronization 236 is metadata with a domain-specific concept (e.g., seek a video to a current time, or change an opacity of a particular video).

Dynamic adaptation 238 may refer to a storytelling technique through which adjustments to the visual narrative(s) are performed in real-time based on any ongoing change(s) in the audio content. The technique is beneficial for live entertainment performances, where unpredictability and spontaneity are common. An example input to dynamic adaptation 238 is a sensor reading or captured image from a live venue and an example output from dynamic adaptation 238 is a change to an overall lighting intensity of the venue or a type of video to be played.

Contextual relevance 240 may refer to a storytelling technique through which relevance of the visual narrative(s), with respect to the audio content and any change(s) there-throughout, is maintained. For instance, calm/serene audio content may favor more tranquil and smooth visuals, whereas upbeat audio content may alternatively favor more energetic and vibrant visuals. An example input to contextual relevance 240 is an audio stream and an example output from contextual relevance 240 is audio stream characteristics, like tempo, beats per minute, key, patterns, etc.

Emotional resonance 242 may refer to a storytelling technique through which an emotional impact of the live entertainment performance is enhanced. For example, Emotional resonance 242 may include the selection and arrangement of visual elements with the objective of amplifying or complementing the audio emotional undertone(s) provided by the example generative AI model 110 (described with respect to FIG. 2C). An example input to emotional resonance 242 is audio stream or metadata (e.g., comment metadata to a track being played in the audio stream) and an example output from emotional resonance 242 is metadata regarding an emotional event that can be used as an input to the generative AI model 110.

Feedback integration 244 may refer to a storytelling technique through which ambient feedback, received from one or more ambient feedback sources 122 (described with respect to FIG. 1), is incorporated into the visual narrative creation process. Feedback integration 232 functions similarly to the feedback integration 232 functionality of the video conversion engine 116 (see e.g., FIG. 2D). An example input to feedback integration 244 is sensor data (e.g., luminance, color, and lighting intensity), captured imagery, or captured sound from a live venue and an example output from feedback integration 244 is an event that can be used as an input to the generative AI model 110 of FIG. 2C.

Visual cohesion and flow 246 refers to a storytelling technique through which any visual elements used in the creation of a visual narrative are cohesive with one another, as well as with the audio content. The technique, said another way, ensures that the visual elements flow seamlessly from one visual element to the next, thereby maintaining aesthetic harmony and visual interest throughout the live entertainment performance. An example input to visual cohesion and flow 246 is text, video, image, and/or audio from the audio content or any ambient feedback source, and an example output includes one or more domain-specific concepts (e.g., seeking a video to a current time, or changing an opacity of a particular video).

While FIG. 2E shows a configuration of elements, other configurations may be used without departing from the scope described herein. For example, in alternative embodiments, aspects described with respect to the example storytelling algorithm 112 may be omitted, added, or substituted for alternative aspects.

### Example Method for Presenting an AI-Enhanced Visual Experience

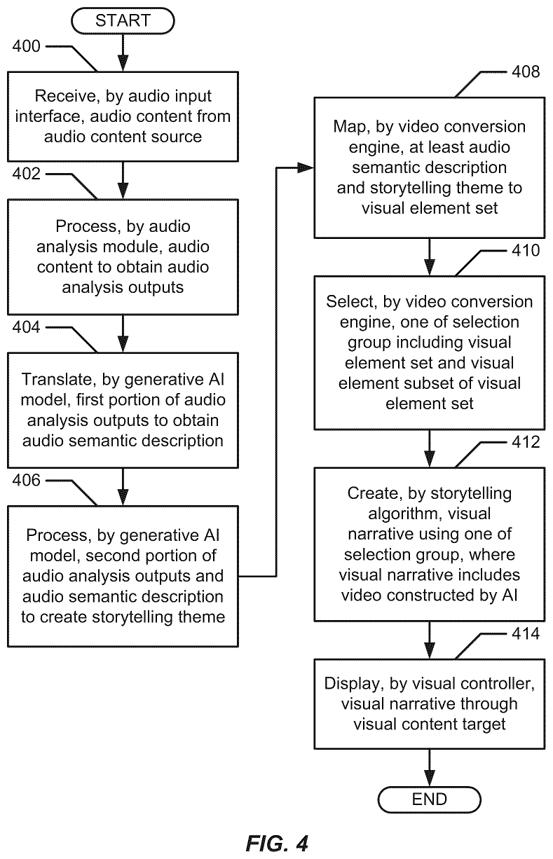

FIGS. 3A-3C depict a flowchart describing an example method for presenting an AI-enhanced visual experience in accordance with one or more aspects described herein. In some aspects, the example method may be performed using an AI-driven AV live entertainment platform such as depicted and described with respect to FIG. 1.

Turning to FIG. 3A, at block 300, an AI-driven live entertainment platform (e.g., platform 100 of FIG. 1) is configured, such as by the customization and control interface 132 of FIG. 1, for an entertainment venue. Examples of the entertainment venue include, but are not limited to, a concert, a night club, a symphony, and a theater.

At block 302, audio content is received, such as by the audio input interface 106 and from an audio content source 102 of FIG. 1. Examples of the audio content source 102 include, but are not limited to, a microphone, DJ equipment, a musical instrument, and a digital audio file. For any analog audio content source, the audio content captured therefrom may be converted into a digital format. Further, concurrent with or following reception of the audio content, audio content metadata, descriptive of the audio content, is also received.

At block 304, audio content metadata received at block 302 is parsed, such as by the audio metadata manager 202 of FIG. 2A. Through the parsing, one or more of: audio source information, audio temporal data, audio technical specifications, and audio contextual information is/are obtained.

At block 306, audio content received at block 302 is processed, such as by the audio analysis module 108 of FIG. 2B using the waveform analysis 204 functionality thereof. Through the waveform analysis, an audio analysis output in the form of one or more audio waveform components is obtained.

At block 308, the audio content received at block 302 is further processed, such as by the audio analysis module 108 of FIG. 2B using the feature extraction 206 functionality thereof. Through the feature extraction, another audio analysis output in the form of one or more audio complex attributes is obtained.

At block 310, the audio content received at block 302 is further processed, such as by the audio analysis module 108 of FIG. 2B using the spectral analysis 208 functionality thereof. Through the spectral analysis, another audio analysis output in the form of one or more audio sound types is identified.

At block 312, the audio content received at block 302 is further processed, such as by the audio analysis module 108 of FIG. 2B using the pattern recognition 210 functionality thereof. Through the pattern recognition, another audio analysis output in the form of one or more recurring themes or motifs is detected.

At block 314, the audio content received at block 302 is further processed, such as by the audio analysis module 108 of FIG. 2B using the contextual and emotional interpretation 212 functionality thereof. Through the contextual and emotional interpretation, another audio analysis output in the form of one or more of: an audio mood, an audio intensity, and an audio expressiveness is gauged.

At block 316, one or more of: the audio source information, the audio temporal data, the audio technical specifications, and the audio contextual information obtained at block 304 is/are processed, such as by the audio analysis module 108 of FIG. 2B using the metadata integration 214 functionality thereof. Through the metadata integration, an enhanced audio understanding (e.g., knowing information about the audio content that is captured in metadata in prior to loading the audio content or a playing thereof) is produced.

Turning to FIG. 3B, at block 320, one or more of: the audio waveform component(s) obtained at block 306 and the audio complex attribute(s) obtained at block 308 is/are translated, such as by the generative AI model 110 of FIG. 2C using the semantic interpretation 216 functionality thereof. Through the semantic interpretation, an audio semantic description may be obtained. Audio semantic description encompasses a textual description of any input(s) (e.g., audio, text, video, image). The textual description may differ depending on, or may be molded by, a current role (e.g., image generator, video generator, etc.) assigned to the generative AI model 110, with the generative AI model outputs also being different based on the aforementioned current role.

At block 322, the audio content received at block 302 is processed, such as by the generative AI model 110 of FIG. 2C using the contextual understanding 218 functionality thereof. Through contextual understanding, one or more audio embedded contexts may be identified. Examples of the audio embedded context(s) include, but are not limited to, key, tempo, waveform and/or spectral analysis outputs (as described above in FIG. 2B), and an overall envelope of the audio content.

At block 324, audio content received at block 302 is further processed, such as by the generative AI model 110 of FIG. 2C using the emotional analysis 220 functionality thereof. Through the emotional analysis, one or more audio emotional undertones are detected. As described herein, the generative AI model invokes a given functionality (e.g., emotional analysis 218, etc.) thereof by first loading a prompt that assigns a role to the generative AI model pertinent to the given functionality.

At block 326, one or more of: the audio semantic description obtained at block 320, the audio embedded context(s) identified at block 322, and the audio emotional undertone(s) detected at block 324 is/are processed, such as by the generative AI model 110 of FIG. 2C using the narrative suggestion 222 functionality thereof. Through the narrative suggestion, one or more storytelling themes may be created.

At block 328, at least the audio semantic description obtained at block 320 and the storytelling theme(s) created at block 326 are mapped, such as by the video conversion engine 116 of FIG. 2D using the semantic mapping 224 functionality thereof. Through the mapping, a visual element set, from the visual element library 120 of FIG. 1, may be identified. The visual element set is identified based on which visual elements are relevant to context of the audio content, such as the mood, genre, rhythm, etc.

At block 330, either the visual element set identified at block 328 or a visual element subset of the visual element set is selected, such as by the video conversion engine 116 of FIG. 2D using the visual element selection 226 functionality thereof. The selection is based on one or more of: the audio mood gauged at block 314, the audio source information obtained at block 304, and the recurring theme(s) (or motif(s)) detected at block 312. Factors to filter visual element set to visual element subset includes emotional classification of the audio content as one or more expressed emotions (e.g., happiness, anger, sorrow, etc.), as well as any theme(s) captured in any ambient feedback.

At block 332, a visual narrative is created, such as by the storytelling algorithm 112 of FIG. 2E using the narrative structuring 234 functionality thereof. Further, the creation may at least be based on the storytelling theme(s) created at block 326 and the audio emotional undertone(s) detected at block 324.

Turning to FIG. 3C, at block 340, the visual narrative created at block 332 is aligned, with the audio content received at block 302, such as by the storytelling algorithm 112 of FIG. 2E using the temporal synchronization 236 functionality thereof. Alternatively, or additionally, the alignment may be performed by the visual conversion engine 116 of FIG. 2D using the synchronization mechanism 230 functionality thereof. Further, the alignment may at least be based on the audio temporal data obtained at block 304.

At block 342, the visual narrative aligned at block 340 is enhanced, such as by the storytelling algorithm 112 of FIG. 2E using the emotional resonance 242 functionality thereof. The enhancement is based on one or more of: the audio emotional undertone(s) detected at block 324, the audio mood if any gauged at block 314, the audio intensity if any gauged at block 314, and the audio expressiveness if any gauged at block 314. Other factors from which the enhancement may be based includes, for example, the tempo, key, and any recognized pattern(s) or recurring theme(s) of the audio content.

At block 344, a lighting sequence is produced, such as by a real-time visual controller 128 of FIG. 1. Production of the lighting sequence may be based on one or more of: the audio waveform component(s) obtained at block 306 and the audio sound type(s) identified at block 310.

At block 346, the visual narrative enhanced at block 342 is displayed, such as by a second real-time visual controller 128 through a visual content target 130 of FIG. 1. Concurrent with the display of the visual narrative, the lighting sequence produced at block 344 is also displayed, such as by the real-time visual controller 128 of FIG. 1 responsible for its production, through a second visual content target 130, such as a strobe light, a moving head light, a laser light, etc.

At block 348, ambient feedback is received, such as by the interactive feedback system 126 of FIG. 1 from one or more ambient feedback sources 122.

At block 350, one or more manual visual changes is received, such as by the customization and control interface 132 of FIG. 1 from a user. Examples of the manual visual change(s) include, but are not limited to, luminance adjustments directed to the light device(s), opaqueness changes any different or overlapping visual narratives being concurrently displayed, and the activation or deactivation of any special effects or features associated with the employed visual content target(s) 130 of FIG. 1.

At block 352, the visual narrative displayed at block 346 is adjusted, such as by the storytelling algorithm 112 of FIG. 2E using the dynamic adaptation 238 and/or the feedback integration 232 functionality/functionalities thereof. Alternatively, or additionally, the adjustment is performed by the video conversion engine 116 of FIG. 2D using the feedback integration 232 functionality thereof. Further, the adjustment is based on the ambient feedback received at block 348 and/or the manual visual change(s) received at block 350. Optionally, adjustments to the lighting sequence displayed at block 346 are also made based on the ambient feedback and/or the manual visual change(s).

While the various blocks outlined and described in FIGS. 3A-3C are presented and described sequentially, some or all blocks may be executed in different orders, may be combined or omitted, and some or all blocks may be executed in parallel in other examples.

### Example Method for Presenting an AI-Enhanced Visual Experience

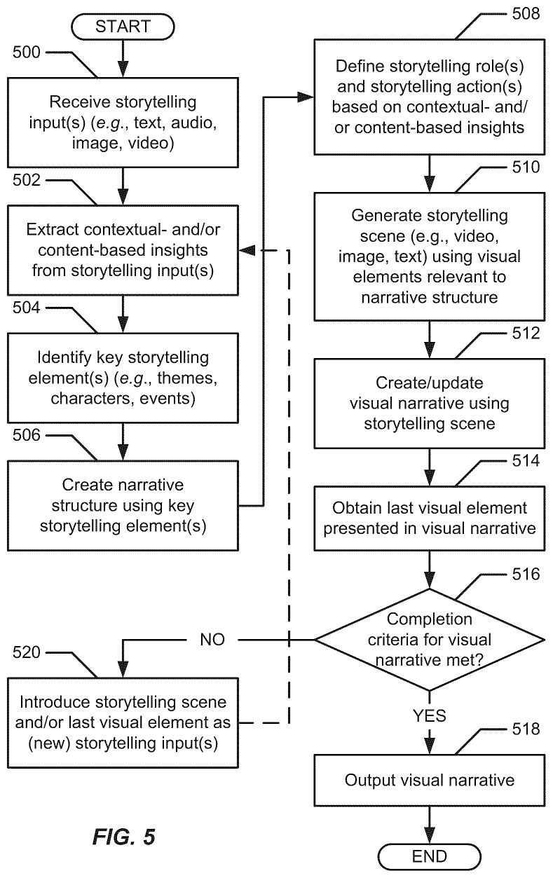

FIG. 4 depicts a flowchart describing an example method for presenting an AI-enhanced visual experience in accordance with one or more aspects described herein. In some aspects, the example method may be performed using an AI-driven AV live entertainment platform such as depicted and described with respect to FIG. 1.

Turning to FIG. 4, at block 400, audio content is received, such as by an audio input interface 106 of FIGS. 1 & 2A from an audio content source 102 of FIG. 1.

At block 402, the audio content received at block 400 is processed, such as by an audio analysis module 108 of FIGS. 1 & 2B to obtain audio analysis outputs.

In some aspects, the audio analysis outputs include audio waveform components, audio complex attributes, audio embedded contexts, and audio emotional undertones.

At block 404, a first portion of the audio analysis outputs obtained at block 402 is translated, such as by a generative AI model 110 of FIGS. 1 & 2C to obtain an audio semantic description.

In some aspects, the first portion of the audio analysis outputs includes one or more of: the audio waveform components and the audio complex attributes.

At block 406, a second portion of the audio analysis outputs obtained at block 402 and the audio semantic description obtained at block 404 is processed, such as by the generative AI model 110 of FIGS. 1 & 2C to create a storytelling theme.

In some aspects, the second portion of the audio analysis outputs includes one or more of: the audio embedded contexts and the audio emotional undertones.

At block 408, at least the audio semantic description obtained at block 404 and the storytelling theme created at block 406 is mapped, such as by a video conversion engine 116 of FIGS. 1 & 2D to a visual element set.

At block 410, one of a selection group including the visual element set identified at block 408 and a visual element subset of the visual element set is selected, such as by the video conversion engine 116 of FIGS. 1 & 2D.

In some aspects, selecting the one of the selection group is based on one or more of: an audio mood, audio source information including an audio genre and an audio rhythm, and a recurring theme.

In some aspects, processing the audio content further obtains one or more of: the audio mood, an audio intensity, an audio expressiveness, and the recurring theme.

In some aspects, the example method further includes: determining, such as by the audio input interface 106 of FIGS. 1 & 2A and concurrent with or after reception of the audio content, audio content metadata from the audio content source 102 of FIG. 1; and parsing, such as by the audio analysis module 108 of FIGS. 1 & 2B, the audio content metadata to obtain one or more of: the audio source information, audio temporal data, audio technical specifications, and audio contextual information.

In some aspects, the example method further includes, after parsing the audio content metadata, processing, such as by the audio analysis module 108 of FIGS. 1 & 2B and to produce an enhanced audio understanding, one or more of: the audio source information, the audio temporal data, the audio technical specifications, and the audio contextual information.

At block 412, a visual narrative is created, such as by a storytelling algorithm 112 of FIGS. 1 & 2E using the one of the selection group selected at block 410, where the visual narrative includes a video constructed by AI.

At block 414, the visual narrative is displayed, such as by a visual controller 128 of FIG. 1 through a visual content target 130 also of FIG. 1.

In some aspects, the visual content target includes one of: a display screen, a media projector, a virtual reality device, and an augmented reality device.

In some aspects, the example method further includes, after displaying the visual narrative: receiving, such as by an interactive feedback system 126 of FIG. 1, ambient feedback from an ambient feedback source 122 also of FIG. 1; and adjusting, by the storytelling algorithm of FIGS. 1 & 2E, the visual narrative based on the ambient feedback.

In some aspects, the example method further includes, after displaying the visual narrative: receiving, such as by a customization and control interface 132 of FIG. 1, a manual visual change from a user; and adjusting, such as by the storytelling algorithm 112 of FIGS. 1 & 2E, the visual narrative based on the manual visual change.

In some aspects, the example method further includes, prior to displaying the visual narrative, aligning, such as by the storytelling algorithm 112 of FIGS. 1 & 2E, the visual narrative with the audio content based on the audio temporal data.

In some aspects, the example method further includes, concurrent with displaying the visual narrative, displaying, such as by a second visual controller 128 of FIG. 1 and through a second visual content target 130 also of FIG. 1, a lighting sequence based on one or more of: the audio waveform components and audio sound types.

In some aspects, processing the audio content further obtains the audio sound types.

In some aspects, the second visual content target includes a lighting device.

While the various blocks outlined and described in FIG. 4 are presented and described sequentially, some or all blocks may be executed in different orders, may be combined or omitted, and some or all blocks may be executed in parallel in other examples.

### Example Method for General Execution of a Storytelling Algorithm

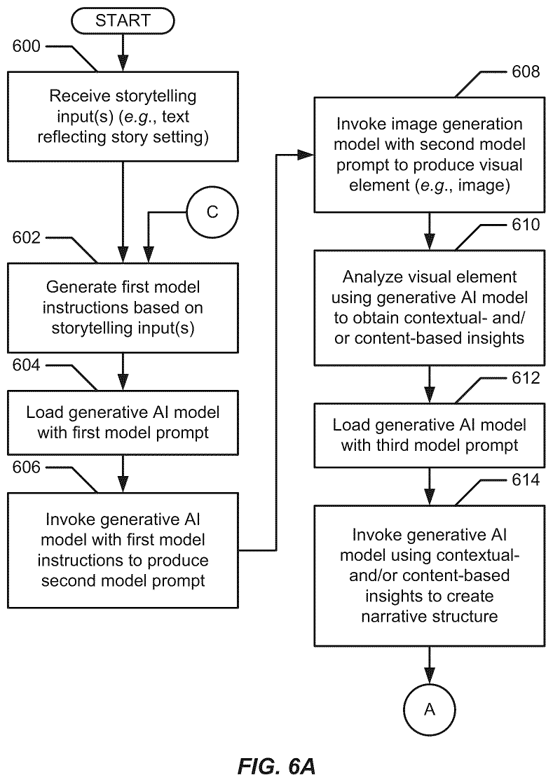

FIG. 5 depicts a flowchart describing an example method for general execution of a storytelling algorithm in accordance with one or more aspects described herein. In some aspects, the example method may be performed using a storytelling algorithm such as depicted and described with respect to FIGS. 1 & 2E.

Turning to FIG. 5, at block 500, one or more storytelling inputs is/are received. Each storytelling input is one of: (a) a text input from an audio content source 102 of FIG. 1 or an ambient feedback source 122 also of FIG. 1; (b) an audio input from the audio content source 102 or the ambient feedback source 122; (c) an image input from the ambient feedback source 122; and (d) a video input from the ambient feedback source 122. Further, each storytelling input is intended to reflect a story setting.

At block 502, contextual-and/or content-based insights are extracted from the storytelling input(s) received at block 500.

At block 504, one or more key storytelling elements is/are identified. Examples of the key storytelling element(s) include, but are not limited to, one or more themes, one or more characters, and one or more events.

At block 506, a narrative structure is created using the key storytelling element(s) identified at block 504. The narrative structure includes an engaging storyline.

At block 508, one or more storytelling roles, as well as one or more storytelling actions, are defined based on the contextual- and/or content-based insights extracted at block 502.

At block 510, a storytelling scene is generated using visual elements relevant to the narrative structure created at block 506. The storytelling scene is presented in the form of a video, an image, or text.

At block 512, a visual narrative is either created (if the visual narrative has yet to be created) or updated (if the visual narrative already exists) using the storytelling scene generated at block 510.

At block 514, a last visual element, presented in the visual narrative created (or updated) at block 512, is obtained.

At block 516, a determination is made as to whether a completion criteria for the visual narrative created (or updated) at block 512 has been met. The completion criteria includes one or more conditions for terminating the creation (or updating) of the visual narrative. Examples of the completion criteria include, but are not limited to: a total duration of the visual narrative matching a duration of the audio content; a waveform amplitude of the audio content, spanning the last seconds (or other specified time period) of the latest storytelling scene generated at block 510, falling below zero; and a number of iterations, designated by the user or derived through a portion of the audio content metadata, setting a limitation to the number of storytelling scenes should be created. If the completion criteria is met, then the example method proceeds to block 518. On the other hand, if the completion criteria is not met, then the example method alternatively proceeds to block 520.

At block 518, following the determination at block 516 that the completion criteria for the visual narrative created (or updated) at block 512 is met, the visual narrative is outputted.

At block 520, following the alternate determination at block 516 that the completion criteria for the visual narrative created (or updated) at block 512 is not met, one or more new storytelling inputs is/are introduced. The new storytelling input(s) include(s) the storytelling scene generated at block 510 and/or the last visual element obtained at block 514.

Hereinafter, the example method proceeds to block 502 (described above).

While the various blocks outlined and described in FIG. 5 are presented and described sequentially, some or all blocks may be executed in different orders, may be combined or omitted, and some or all blocks may be executed in parallel in other examples.

### Example Method for Execution of a Storytelling Algorithm Given a Text Input

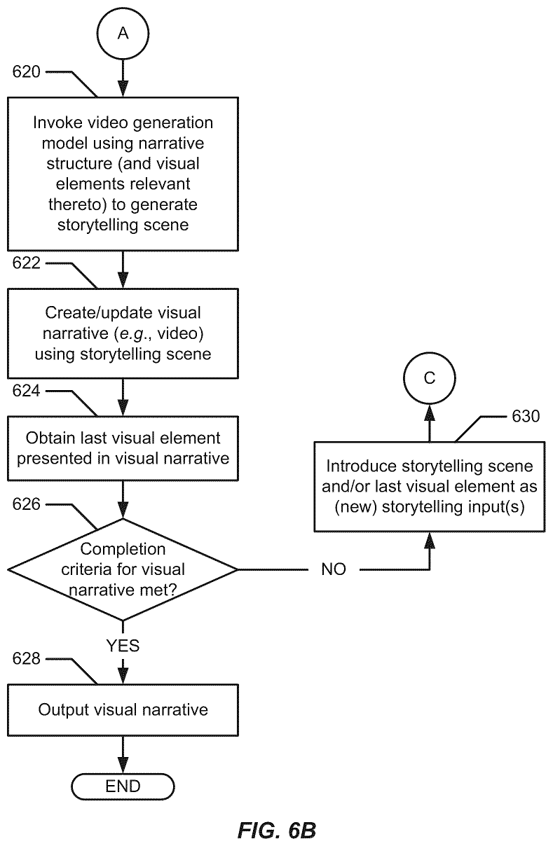

FIGS. 6A and 6B depict a flowchart describing an example method for execution of a storytelling algorithm given a text input in accordance with one or more aspects described herein. In some aspects, the example method may be performed using a storytelling algorithm such as depicted and described with respect to FIGS. 1 & 2E.

Turning to FIG. 6A, at block 600, one or more storytelling inputs is received. The storytelling input(s) include(s) a text input reflecting a story setting.

At block 602, first model instructions are generated based on the storytelling input(s) received at block 600.

At block 604, a generative AI model, as described above with respect to FIGS. 1 & 2C, is loaded with a first model prompt.

At block 606, the generative AI model loaded at block 604 is invoked with the first model instructions generated at block 602. Invocation of the generative AI model results in the production of a second model prompt.

At block 608, an image generation model (included as part of the visual conversion engine 116 of FIG. 1) is invoked with the second model prompt produced at block 606. Invocation of the image generation model results in the production of a visual element in the format of an image.

At block 610, the visual element produced at block 608 is analyzed using the generative AI model. Image analysis of the visual element yields the obtaining of contextual- and/or content-based insights pertaining to the visual element.

At block 612, the generative AI model is loaded with a third model prompt.

At block 614, the generative AI model is invoked using the contextual- and/or content-based insights obtained at block 610. Invocation of the generative AI model subsequently creates a narrative structure.

Turning to FIG. 6B, at block 620, a video generation model (included as part of the visual conversion engine 116 of FIG. 1) is invoked using the narrative structure created at block 614. Invocation of the video generation model may also use various visual elements. Further, the invocation results in the generation of a storytelling scene.

At block 622, a visual narrative is either created (if the visual narrative has yet to be created) or updated (if the visual narrative already exists) using the storytelling scene generated at block 620.

At block 624, a last visual element, presented in the visual narrative created (or updated) at block 622, is obtained.

At block 626, a determination is made as to whether a completion criteria for the visual narrative created (or updated) at block 622 has been met. The completion criteria includes one or more conditions for terminating the creation (or updating) of the visual narrative. Examples of the completion criteria include, but are not limited to: a total duration of the visual narrative matching a duration of the audio content; a waveform amplitude of the audio content, spanning the last seconds (or other specified time period) of the latest storytelling scene generated at block 620, falling below zero; and a number of iterations, designated by the user or derived through a portion of the audio content metadata, setting a limitation to the number of storytelling scenes should be created. If the completion criteria is met, then the example method proceeds to block 628. On the other hand, if the completion criteria is not met, then the example method alternatively proceeds to block 630.

At block 628, following the determination at block 626 that the completion criteria for the visual narrative created (or updated) at block 622 is met, the visual narrative is outputted.

At block 630, following the alternate determination at block 626 that the completion criteria for the visual narrative created (or updated) at block 622 is not met, one or more new storytelling inputs is/are introduced. The new storytelling input(s) include(s) the storytelling scene generated at block 620 and/or the last visual element obtained at block 624.

Hereinafter, the example method proceeds to block 602 (described above).

While the various blocks outlined and described in FIGS. 6A and 6B are presented and described sequentially, some or all blocks may be executed in different orders, may be combined or omitted, and some or all blocks may be executed in parallel in other examples.

### Example Method for Execution of a Storytelling Algorithm Given an Image or Video Input

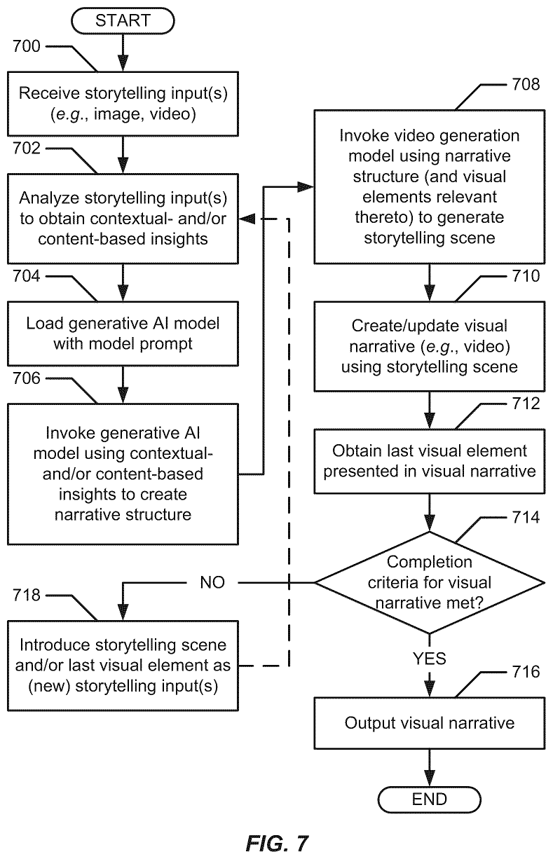

FIG. 7 depicts a flowchart describing an example method for execution of a storytelling algorithm given an image or video input in accordance with one or more aspects described herein. In some aspects, the example method may be performed using a storytelling algorithm such as depicted and described with respect to FIGS. 1 & 2E.

Turning to FIG. 7, at block 700, one or more storytelling inputs is received. The storytelling input(s) include(s) an image, or a video, reflecting a story setting.

At block 702, the storytelling input(s) received at block 700 undergo analysis. The analysis results in obtaining contextual-and/or content-based insights.

At block 704, a generative AI model, as described above with respect to FIGS. 1 & 2C, is loaded with a model prompt.

At block 706, the generative AI model loaded at block 704 is invoked using the contextual- and/or content-based insights obtained at block 702. Invocation of the generative AI model results in the creation of a narrative structure.

At block 708, a video generation model (included as part of the visual conversion engine 116 of FIG. 1) is invoked using the narrative structure created at block 706. Invocation of the video generation model may also use various visual elements. Further, the invocation results in the generation of a storytelling scene.

At block 710, a visual narrative is either created (if the visual narrative has yet to be created) or updated (if the visual narrative already exists) using the storytelling scene generated at block 708.

At block 712, a last visual element, presented in the visual narrative created (or updated) at block 710, is obtained.

At block 714, a determination is made as to whether a completion criteria for the visual narrative created (or updated) at block 710 has been met. The completion criteria includes one or more conditions for terminating the creation (or updating) of the visual narrative. Examples of the completion criteria include, but are not limited to: a total duration of the visual narrative matching a duration of the audio content; a waveform amplitude of the audio content, spanning the last seconds (or other specified time period) of the latest storytelling scene generated at block 708, falling below zero; and a number of iterations, designated by the user or derived through a portion of the audio content metadata, setting a limitation to the number of storytelling scenes should be created. If the completion criteria is met, then the example method proceeds to block 716. On the other hand, if the completion criteria is not met, then the example method alternatively proceeds to block 718.

At block 716, following the determination at block 714 that the completion criteria for the visual narrative created (or updated) at block 710 is met, the visual narrative is outputted.

At block 718, following the alternate determination at block 714 that the completion criteria for the visual narrative created (or updated) at block 710 is not met, one or more new storytelling inputs is/are introduced. The new storytelling input(s) include(s) the storytelling scene generated at block 708 and/or the last visual element obtained at block 712.

Hereinafter, the example method proceeds to block 702 (described above).

While the various blocks outlined and described in FIG. 7 are presented and described sequentially, some or all blocks may be executed in different orders, may be combined or omitted, and some or all blocks may be executed in parallel in other examples.

### Example Entertainment Venue Setup for Presenting an AI-Enhanced Visual Experience

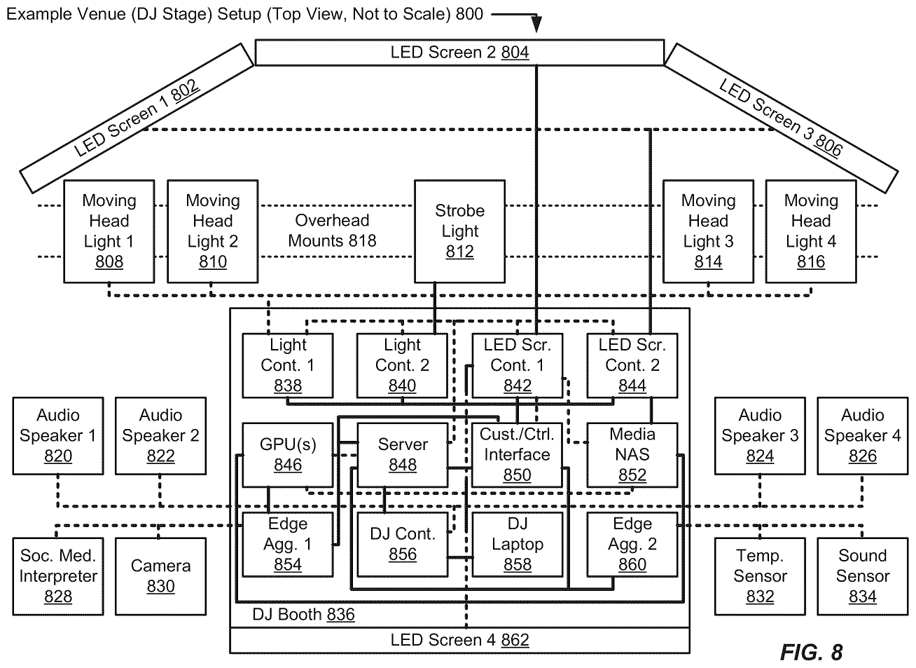

FIG. 8 depicts an example entertainment venue setup 800 for presenting an AI-enhanced visual experience through AI-driven AV live entertainment platforms, such as the platform 100 depicted and described with respect to FIG. 1. The example entertainment venue setup 800 illustrated and described herein is representative of a top view of an indoor or outdoor DJ stage configuration.

The example entertainment venue setup 800 includes a DJ booth 836 that reflects a space where the DJ(s) perform(s), where which much of the music and visual controlling elements reside. To that extent, the DJ booth 836 includes a light controller 1 838, a light controller 2 840, a led screen controller 1 842, a led screen controller 2 844, one or more GPUs 846, a server 848, a customization and control interface 850, a media NAS 852, an edge aggregator 1 854, a DJ controller 856, a DJ laptop 858, and an edge aggregator 2 860.

The example entertainment venue setup 800 further includes a number of other devices pertinent to the performance of the entertainment. The other devices include a LED screen 1 802, a LED screen 2 804, a LED screen 3 806, a moving head light 1 808, a moving head light 2 810, a strobe light 812, a moving head light 3 814, a moving head light 4 816, an audio speaker 1 820, an audio speaker 2 822, an audio speaker 3 824, an audio speaker 4 826, a social media interpreter 828, a camera 830, a temperature sensor 832, a sound sensor 834, and a LED screen 4 862. The four moving head lights 808, 810, 814, 816, as well as the strobe light 812, are positioned on or hang below a pair of overhead mounts 818.

The following statements reference components illustrated and described with respect to FIG. 1.

The two light controllers 838, 840 and the two LED screen controllers 842, 844 are examples of the real-time visual controller(s) 128. The GPU(s) 846 is/are example(s) of the GPU(s) 114 whereon the video conversion engine 116 is supported (or included). The server 848 is an example of the computing device 104 whereon the audio input interface 106, the audio analysis module 108, the generative AI model 110, and the storytelling algorithm 112 are supported (or included). The customization and control interface 850 is an example of the customization and control interface 132. The media NAS 852 is an example of the storage device 118 whereon the visual element library 120 is supported (or included). The two edge aggregators 854, 860 are examples of the edge computing device(s) 124 whereon the interactive feedback system 126 is supported (or included). The DJ controller 856 and the DJ laptop 858 are examples of the audio content source(s) 102. The four LED screens 802, 804, 806, 862, the four moving head lights 808, 810, 814, 816, and the strobe light 812 are examples of the visual content target(s) 130. The social media interpreter 828, the camera 830, the temperature sensor 832, and the sound sensor 834 are examples of the ambient feedback source(s) 122.

The entertainment venue setup 800 includes various data interconnections. These data interconnections are reflected in the following statements.

Light controller 1 838 operatively connects to each of the four moving head lights 808, 810, 814, 816. Light controller 2 840 operatively connects to the strobe light 812. LED screen controller 1 842 operatively connects to each of LED screens 2 and 4 804, 862. LED screen controller 2 844 operatively connects to each of LED screens 1 and 3 802, 806. GPU(s) 846 operatively connects to each of the two edge aggregators 854, 860, the server 848, and the media NAS 852. Server 848 operatively connects to each of the two light controllers 838, 840, each of the two LED screen controllers 842, 844, the GPU(s) 846, the customization and control interface 850, each of the two edge aggregators 854, 860, and the DJ controller 856. The customization and control interface 850 operatively connects to each of the two light controllers 838, 840, each of the two LED screen controllers 842, 844, the server 848, and each of the two edge aggregators 854, 860. The media NAS 852 operatively connects to each of the LED screen controllers 842, 844, and the GPU(s) 846. Edge aggregator 1 854 operatively connects to the social media interpreter 828, the camera 830, the GPU(s) 846, the server 848, and the customization and control interface 850. Edge aggregator 2 860 operatively connects to the temperature sensor 832, the sound sensor 834, the GPU(s) 846, the server 848, and the customization and control interface 850. The DJ controller 856 operatively connects to each of the four audio speakers 820, 822, 824, 826, the server 848, and the DJ laptop 858. The DJ laptop 858 operatively connects to the DJ controller 856.

The entertainment venue setup 800 is configured for various interactions, such as described in accordance with FIGS. 3A-3C. These interactions are reflected in the following statements.

Customization and control interface 850 configures each of the following in view of an indoor or outdoor DJ stage performance: (a) the two light controllers 838, 840; (b) the two LED screen controllers 842, 844; (c) the GPU(s) 846; (d) the server 848; (e) the media NAS 852; and (f) the two edge aggregators 854, 860.

Server 848 receives audio content (e.g., digital audio file) and/or audio content metadata from the DJ controller 856 and/or DJ laptop 858. Server 848 processes audio content to obtain audio analysis output(s) (e.g., audio waveform component(s), audio complex attribute(s), audio sound type(s), recurring theme(s) or motif(s), audio mood, audio intensity, audio expressiveness) and metadata parsing output(s) (e.g., audio source information, audio temporal data, audio technical specification(s), audio contextual information). Server 848 processes one or more metadata parsing output(s) to produce an enhanced audio understanding. Server 848 translates a portion of the audio analysis output(s) (e.g., audio waveform component(s) and/or audio complex attribute(s)) to obtain an audio semantic description. Server 848 further processes the audio content to identify audio embedded context(s) and to detect audio emotional undertone(s). Server 848 processes the audio semantic description, audio embedded context(s), and/or audio emotional undertone(s) to create one or more storytelling theme(s).

GPU(s) 846 receive(s) the audio semantic description, storytelling theme(s), a portion of the audio analysis output(s) (e.g., recurring theme(s) or motif(s), audio mood, audio intensity), and a portion of the metadata parsing output(s) (e.g., audio source information) from server 848. GPU(s) 846 identify/identifies visual element set, stored on media NAS 852, based on the audio semantic description and/or storytelling theme(s). GPU(s) 846 select(s) visual element selection group (i.e., cither visual element set or visual element subset of visual element set) based on portion of the audio analysis output(s) and/or portion of the metadata analysis output(s).

Server 848 receives visual element selection group from the GPU(s) 846, or the GPU(s) 846 optionally receive(s) the audio emotional undertone(s) from the server 848. Server 848 or the GPU(s) 846 create(s) first and second visual narratives using the visual element selection group and based on the storytelling theme(s) and/or audio emotional undertone(s). Server 848 optionally receives the first and second visual narratives from the GPU(s) 846, or the GPU(s) optionally receive(s) the audio content and audio temporal data from the server 848. Server 848 or the GPU(s) 846 align(s) the first and second visual narratives with the audio content at least based on the audio temporal data. Server 848 enhances the (aligned) first and second visual narratives based on the audio emotional undertone(s) and/or another portion of the audio analysis output(s) (e.g., audio mood, audio intensity, audio expressiveness).

LED screen controller 1 842 receives the (enhanced) first visual narrative from the server 848. LED screen controller 1 842 displays the (enhanced) first visual narrative through LED screens 2 & 4 804, 462. LED screen controller 2 844 receives the (enhanced) second visual narrative from the server 848. LED screen controller 2 844 displays the (enhanced) second visual narrative through LED screens 1 & 3 802, 806. Light controller 1 838 and light controller 2 840 each receives another portion of the audio analysis output(s) (e.g., audio waveform component(s), audio sound type(s)) from the server 848. Light controller 1 838 produces a first lighting sequence based on the other portion of the audio analysis output(s). Light controller 1 838 displays the first lighting sequence through the four moving head lights 808, 810, 814, 816. Light controller 2 840 produces a second lighting sequence based on the other portion of the audio analysis output(s). Light controller 2 840 displays the second lighting sequence through the strobe light 812.

Social media interpreter 828 receives social media reaction(s) (e.g., ambient feedback) to the entertainment performance from one or more attendees. Camera 830 captures tattoo image(s) (e.g., ambient feedback) on or of the attendee(s). Edge aggregator 1 854 receives the social media reaction(s) from the social media interpreter 828 and the tattoo image(s) from the camera 830. Temperature sensor 832 detects venue temperature(s) (e.g., ambient feedback) within the entertainment venue. Sound sensor 834 detects crowd decibel(s) (e.g., ambient feedback) amongst the attendee(s). Edge aggregator 2 860 receives crowd temperature(s) from the temperature sensor 832 and the crowd decibel(s) from the sound sensor 834.

Server 848, the GPU(s) 846, and/or the customization and control Interface 850 receive(s) the social media reaction(s) and tattoo image(s) from edge aggregator 1 854, as well as the venue temperature(s) and crowd decibel(s) from edge aggregator 2 860. Server 848 or the GPU(s) 846 or the customization and control interface 850 adjusts the (enhanced) first and/or second visual narrative(s) based on the social media reaction(s), tattoo image(s), venue temperature(s), and/or crowd decibel(s). Server 848 optionally receives the (adjusted) first and/or second visual narrative(s) from the GPU(s) 846 or the customization and control interface 850.

LED screen controller 1 842 receives the (adjusted) first visual narrative from the server 848. LED screen controller 1 842 displays the (adjusted) first visual narrative through LED screens 2 & 4 804, 862. LED screen controller 2 844 optionally receives the (adjusted) second visual narrative from the server 848. LED screen controller 2 844 optionally displays the (adjusted) second visual narrative through LED screens 1 & 3 802, 806.

### Example Computing System for Presenting an AI-Enhanced Visual Experience

FIG. 9 depicts an example computing system 900 for presenting an AI-enhanced visual experience. The example computing system 900 includes one or more computer processors 902, non-persistent storage 904, persistent storage 920, one or more output devices 922, one or more input devices 924, and one or more communication interfaces 926. Each of these components is described below.

The computer processor(s) 902 each represents an integrated circuit configured for processing computer-readable instructions (e.g., program code) to perform various functions. For example, the computer processor(s) 902 each include one or more cores, or micro-cores, of a central processing unit (CPU). By way of other examples, the computer processor(s) 902 each represents a microcontroller, an application-specific integrated circuit (ASIC), a field programmable gate array (FPGA), or any other integrated circuit configured to execute computer-readable instructions.

The non-persistent storage 904 includes volatile storage (or memory), or computer storage (or memory) configured to temporarily retain computer-readable instructions and/or data while electrical power is present. When the electrical power is interrupted or absent, the temporarily retained computer-readable instructions and/or data becomes lost. Examples of non-persistent storage 904 include, but are not limited to, random access memory (RAM) and cache memory.

The non-persistent storage 904 includes a capturing element 906, a processing element 908, a translating element 910, a mapping element 912, a selecting element 914, a creating element 916, and a displaying element 918.

In certain embodiments, the receiving element 906 is configured to receive audio content from an audio content source, as depicted and described above with respect to block 400 in FIG. 4.

In certain embodiments, the processing element 908 is configured to process the audio content to obtain audio analysis outputs, as well as to process a second portion of the audio analysis outputs and an audio semantic description to create a storytelling theme, as depicted and described above with respect to blocks 402 and 406 in FIG. 4.

In certain embodiments, the translating element 910 is configured to translate a first portion of the audio analysis outputs to obtain the audio semantic description, as depicted and described above with respect to block 404 in FIG. 4.

In certain embodiments, the mapping element 912 is configured to map at least the audio semantic description and the storytelling theme to a visual element set, as depicted and described above with respect to block 408 in FIG. 4.

In certain embodiments, the selecting element 914 is configured to select one of a selection group including the visual element set and a visual element subset of the visual element set, as depicted and described above with respect to block 410 in FIG. 4.

In certain embodiments, the creating element 916 is configured to create a visual narrative using the one of the selection group, where the visual narrative includes a video constructed by AI, as depicted and described above with respect to block 412 in FIG. 4.

In certain embodiments, the displaying element is configured to display the visual narrative through a visual content target, as depicted and described above with respect to block 414 in FIG. 4.

The persistent storage 920 includes non-volatile storage (or memory), or computer storage (or memory) configured to permanently retain computer-readable instructions and/or data even after electrical power is removed. Examples of persistent storage 920 include, but are not limited to, read-only memory (ROM), flash memory, solid state drives (SSD), ferroelectric RAM, hard disk drives (HDD), magnetic tape, and optical drives (e.g., compact disk (CD) drives and digital versatile disk (DVD) drives).

The output device(s) 922 each represent a peripheral configured to output information in a human-comprehensible form. Examples of the output device(s) 922 include, but are not limited to: a display screen (which provides visual outputs; e.g., a liquid crystal display (LCD) screen, a plasma display screen, a touchscreen, a light-emitting diode (LED) display screen, a media projector, etc.); a speaker or sound card (which provides audio outputs); a printer (which provides physical form outputs; e.g., an inkjet printer, a laser printer, a three-dimensional (3D) printer, etc.); and a global positioning system (GPS) (which provides geolocation coordinate outputs).

The input device(s) 924 each represent a peripheral configured to enable one or more users to interact with, or input information into, the example computing system 900. Examples of the input device(s) 924 include, but are not limited to: a touchscreen (which permits tactile or stylus inputs); a keyboard (which permits typed inputs); a mouse, joystick, or trackpad (which permits pointing and two-dimensional (2D) motion inputs); a microphone (which permits audio inputs); and a camera or scanner (which permits visual inputs).

The communication interface(s) 926 each represent an integrated circuit configured to enable communications between the example computing system 900 and one or more other computing systems (not shown). The communications may be propagated through a network (not shown), such as a local area network (LAN), a wide area network (WAN) (e.g., the Internet), a mobile network, any other network type, or any combination thereof. The network, furthermore, may be implemented using any combination of wired and/or wireless connections, and subsequently, may employ any combination of wired and/or wireless communication protocols, respectively. Examples of the communication interface(s) 926 include, but are not limited to: a network card, a network adapter, and an antenna.

One or more of the output device(s) 922 may be the same or different from the input device(s) 924. Any peripheral that performs both input and output functions represents an input-output (IO) device. Further, any of the output device(s) 922 and/or the input device(s) 924 may be locally or remotely connected to the computer processor(s) 902, non-persistent storage 904, and persistent storage 920.

Software instructions in the form of computer-readable instructions, or program code, to perform aspects described herein may be stored, in whole or in part, and temporarily or permanently, on non-transitory computer readable media. Examples of non-transitory computer readable media include, but are not limited to, a CD, a DVD, a storage device, a diskette, a tape, flash memory, and cloud storage. The software instructions may correspond to computer-readable instructions, or program code, which when executed by the computer processor(s) 902, enables the computer processor(s) 902 to perform one or more aspects described herein.

While FIG. 9 shows a configuration of aspects, other configurations may be used without departing from the scope described herein. For example, in alternative embodiments, aspects described with respect to the example computing system 900 may be omitted, added, or substituted for alternative aspects.

### Example Clauses

Implementation examples are described in the following numbered clauses:

Clause 1: A method for presenting an artificial intelligence (AI)-enhanced visual experience, comprising: receiving, by an audio input interface, audio content from an audio content source; processing, by an audio analysis module, the audio content to obtain audio analysis outputs; translating, by a generative AI model, a first portion of the audio analysis outputs to obtain an audio semantic description; processing, by the generative AI model, a second portion of the audio analysis outputs and the audio semantic description to create a storytelling theme; mapping, by a video conversion engine, at least the audio semantic description and the storytelling theme to a visual element set; selecting, by the video conversion engine, one of a selection group comprising the visual element set and a visual element subset of the visual element set; creating, by a storytelling algorithm, a visual narrative using the one of the selection group, the visual narrative comprising a video constructed by AI; and displaying, by a visual controller, the visual narrative through a visual content target.

Clause 2: The method of Clause 1, wherein the audio analysis outputs comprise audio waveform components, audio complex attributes, audio embedded contexts, and audio emotional undertones.

Clause 3: The method of Clause 2, wherein the first portion of the audio analysis outputs comprises one or more of: the audio waveform components and the audio complex attributes.

Clause 4: The method of Clause 2, wherein the second portion of the audio analysis outputs comprises one or more of: the audio embedded contexts and the audio emotional undertones.

Clause 5: The method of any one of Clauses 1-2, wherein selecting the one of the selection group is based on one or more of: an audio mood, audio source information comprising an audio genre and an audio rhythm, and a recurring theme.

Clause 6: The method of Clause 5, wherein processing the audio content further obtains one or more of: the audio mood, an audio intensity, an audio expressiveness, and the recurring theme.

Clause 7: The method of Claus 5, further comprising: determining, by the audio input interface and concurrent with or after reception of the audio content, audio content metadata from the audio content source; and parsing, by the audio analysis module, the audio content metadata to obtain one or more of: the audio source information, audio temporal data, audio technical specifications, and audio contextual information.

Clause 8: The method of Clause 7, further comprising, after parsing the audio content metadata, processing, by the audio analysis module and to produce an enhanced audio understanding, one or more of: the audio source information, the audio temporal data, the audio technical specifications, and the audio contextual information.

Clause 9: The method of Clause 7, further comprising, prior to displaying the visual narrative, aligning, by the storytelling algorithm, the visual narrative with the audio content based on the audio temporal data.

Clause 10: The method of Clause 2, further comprising, concurrent with displaying the visual narrative, displaying, by a second visual controller and through a second visual content target, a lighting sequence based on one or more of: the audio waveform components and audio sound types.

Clause 11: The method of Clause 10, wherein processing the audio content further obtains the audio sound types.

Clause 12: The method of Clause 10, wherein the second visual content target comprises a lighting device.

Clause 13: The method of any one of Clauses 1-2 and 5, wherein the visual content target comprises one of: a display screen, a media projector, a virtual reality device, and an augmented reality device.

Clause 14: The method of any one of Clauses 1-2, 5, and 13, further comprising, after displaying the visual narrative: receiving, by an interactive feedback system, ambient feedback from an ambient feedback source; and adjusting, by the storytelling algorithm, the visual narrative based on the ambient feedback.

Clause 15: The method of any one of Clauses 1-2, 5, and 13-14, further comprising, after displaying the visual narrative: receiving, by a customization and control interface, a manual visual change from a user; and adjusting, by the storytelling algorithm, the visual narrative based on the manual visual change.

Clause 16: A live entertainment platform incorporating artificial intelligence (AI) and comprising: a computing device comprising a first computer processor, the first computer processor configured to support: an audio input interface configured to receive audio content, the audio input interface comprising an audio metadata manager, and the audio metadata manager configured to handle audio metadata associated with the audio content, an audio analysis module configured to process the audio content to obtain audio analysis outputs, a generative AI model configured to process the audio analysis outputs to obtain generative AI outputs, and a storytelling algorithm configured to create a visual narrative using one of a selection group comprising a visual element set and a visual element subset of the visual clement set; a graphics processing unit configured to support a video conversion engine, the video conversion engine configured to map the generative AI outputs to the visual element set; a storage device comprising a second computer processor, the second computer processor configured to support a visual element library, and the visual element library configured to store visual elements created by the AI; a visual controller comprising a third computer processor, the third computer processor configured to display the visual narrative; a customization and control interface comprising a fourth computer processor, the fourth computer processor configured to configure the live entertainment platform for an entertainment venue; and an edge computing device comprising a fifth computer processor, the fifth computer processor configured to support an interactive feedback system, and the interactive feedback system configured to receive ambient feedback used to adjust the visual narrative.

Clause 17: The live entertainment platform of Clause 16, wherein the audio content originates from an audio content source, and the audio content source comprises one of: a microphone, disc-jockey (DJ) equipment, a musical instrument, and a digital music file.

Clause 18: The live entertainment platform of any of Clauses 16-17, wherein the visual narrative is displayed through a visual content target, and the visual content target comprises one of: a display screen, a media projector, a virtual reality device, and an augmented reality device.

Clause 19: The live entertainment platform of any of Clauses 16-18, wherein the ambient feedback originates from an ambient feedback source, and the ambient feedback source comprises one of: a microphone, a camera, social media, and an environmental sensor.

Clause 20: The live entertainment platform of any of Clauses 16-19, further comprising: a second visual controller comprising a sixth computer processor, the sixth computer processor configured to display a lighting sequence through a second visual content target, and the second visual content target comprises a lighting device.

Clause 21: A computing system, comprising: non-persistent storage comprising computer-readable instructions; and a computer processor configured to execute the computer-readable instructions and cause the computing system to perform a method in accordance with any one of Clauses 1-15.

Clause 22: A non-transitory computer-readable medium comprising computer-readable instructions, which when executed by a computer processor of a computing system, enables the computing system to perform a method in accordance with any one of Clauses 1-15.

Clause 23: A computing system, comprising for means for performing a method in accordance with any one of Clauses 1-15.

Clause 24: A computer program product embodied on a computer-readable medium comprising code for performing a method in accordance with any one of Clauses 1-15.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various Blocks may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., Blocks of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more Blocks or actions for achieving the methods. The method Blocks and/or actions may be interchanged with one another without departing from the scope of the claims. In other words, unless a specific order of Blocks or actions is specified, the order and/or use of specific Blocks and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35U.S.C. § 112(f) unless the element is expressly recited using the phrase “means for” or, in the case of a method claim, the element is recited using the phrase “Block for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for presenting an artificial intelligence (AI)-enhanced visual experience, comprising:
receiving, by an audio input interface, audio content from an audio content source;
processing, by an audio analysis module, the audio content to obtain audio analysis outputs;
translating, by a generative AI model, a first portion of the audio analysis outputs to obtain an audio semantic description;
processing, by the generative AI model, a second portion of the audio analysis outputs and the audio semantic description to create a storytelling theme;
mapping, by a video conversion engine, at least the audio semantic description and the storytelling theme to a visual element set;
selecting, by the video conversion engine, one of a selection group comprising the visual element set and a visual element subset of the visual element set;
creating, by a storytelling algorithm, a visual narrative using the one of the selection group, the visual narrative comprising a video constructed by the AI; and
displaying, by a visual controller, the visual narrative through a visual content target.

2. The method of claim 1, wherein the audio analysis outputs comprise audio waveform components, audio complex attributes, audio embedded contexts, and audio emotional undertones.

3. The method of claim 2, wherein the first portion of the audio analysis outputs comprises one or more of: the audio waveform components and the audio complex attributes.

4. The method of claim 2, wherein the second portion of the audio analysis outputs comprises one or more of: the audio embedded contexts and the audio emotional undertones.

5. The method of claim 1, wherein selecting the one of the selection group is based on one or more of: an audio mood, audio source information comprising an audio genre and an audio rhythm, and a recurring theme.

6. The method of claim 5, wherein processing the audio content further obtains one or more of: the audio mood, an audio intensity, an audio expressiveness, and the recurring theme.

7. The method of claim 5, further comprising:
determining, by the audio input interface and concurrent with or after reception of the audio content, audio content metadata from the audio content source; and
parsing, by the audio analysis module, the audio content metadata to obtain one or more of: the audio source information, audio temporal data, audio technical specifications, and audio contextual information.

8. The method of claim 7, further comprising, after parsing the audio content metadata, processing, by the audio analysis module and to produce an enhanced audio understanding, one or more of: the audio source information, the audio temporal data, the audio technical specifications, and the audio contextual information.

9. The method of claim 7, further comprising, prior to displaying the visual narrative, aligning, by the storytelling algorithm, the visual narrative with the audio content based on the audio temporal data.

10. The method of claim 2, further comprising, concurrent with displaying the visual narrative, displaying, by a second visual controller and through a second visual content target, a lighting sequence based on one or more of: the audio waveform components and audio sound types.

11. The method of claim 10, wherein processing the audio content further obtains the audio sound types.

12. The method of claim 10, wherein the second visual content target comprises a lighting device.

13. The method of claim 1, wherein the visual content target comprises one of: a display screen, a media projector, a virtual reality device, and an augmented reality device.

14. The method of claim 1, further comprising, after displaying the visual narrative:
receiving, by an interactive feedback system, ambient feedback from an ambient feedback source; and
adjusting, by the storytelling algorithm, the visual narrative based on the ambient feedback.

15. The method of claim 1, further comprising, after displaying the visual narrative:
receiving, by a customization and control interface, a manual visual change from a user; and
adjusting, by the storytelling algorithm, the visual narrative based on the manual visual change.

16. A live entertainment platform incorporating artificial intelligence (AI) and comprising:
a computing device comprising a first computer processor, the first computer processor configured to support:
an audio input interface configured to receive audio content,
the audio input interface comprising an audio metadata manager, and
the audio metadata manager configured to handle audio metadata associated with the audio content,
an audio analysis module configured to process the audio content to obtain audio analysis outputs,
a generative AI model configured to process the audio analysis outputs to obtain generative AI outputs, and
a storytelling algorithm configured to create a visual narrative using one of a selection group comprising a visual element set and a visual element subset of the visual element set;
a graphics processing unit configured to support a video conversion engine, the video conversion engine configured to map the generative AI outputs to the visual element set;
a storage device comprising a second computer processor,
the second computer processor configured to support a visual element library, and
the visual element library configured to store visual elements created by the AI;
a visual controller comprising a third computer processor, the third computer processor configured to display the visual narrative;
a customization and control interface comprising a fourth computer processor, the fourth computer processor configured to configure the live entertainment platform for an entertainment venue; and
an edge computing device comprising a fifth computer processor,
the fifth computer processor configured to support an interactive feedback system, and
the interactive feedback system configured to receive ambient feedback used to adjust the visual narrative.

17. The live entertainment platform of claim 16, wherein:
the audio content originates from an audio content source, and
the audio content source comprises one of: a microphone, disc-jockey (DJ) equipment, a musical instrument, and a digital music file.

18. The live entertainment platform of claim 16, wherein:
the visual narrative is displayed through a visual content target, and
the visual content target comprises one of: a display screen, a media projector, a virtual reality device, and an augmented reality device.

19. The live entertainment platform of claim 16, wherein:
the ambient feedback originates from an ambient feedback source, and
the ambient feedback source comprises one of: a microphone, a camera, social media, and an environmental sensor.

20. The live entertainment platform of claim 16, further comprising:
a second visual controller comprising a sixth computer processor,
the sixth computer processor configured to display a lighting sequence through a second visual content target. and
the second visual content target comprises a lighting device.
